(19) United States
(12) Patent Application Publication
(10) Pub. No.: US 2018/0222588 A1
(43) Pub. Date: Aug. 9, 2018

(54) GALLEY MONUMENT WITH CHARGING STATION

(71) Applicant: Airbus Operations GmbH, Hamburg (DE)

(72) Inventors: Falk BAJORAT, Hamburg (DE); Olaf SCHLATTER, Hamburg (DE)

(21) Appl. No.: 15/878,368

(22) Filed: Jan. 23, 2018

(30) Foreign Application Priority Data
Jan. 24, 2017 (DE) 10 2017 201 103.3

(51) Int. Cl. B64D 11/04; B64D 11/00; B64D 41/00

(52) U.S. Cl. CPC B64D 11/04; B64D 41/00; B64D 11/0007

(57) ABSTRACT

A galley monument has at least one galley element and at least one charging station integrated in a slide-in compartment in the galley monument for charging electrical energy storage of personal electronic devices. The charging station has a locking element having a locking mechanism. The locking mechanism is equipped with an emergency intervention mechanism for opening the locking element in emergency situations.

### CROSS-REFERENCE TO RELATED APPLICATION

This application claims priority to German Patent Application DE 10 2017 201 103.3 filed Jan. 24, 2017, the entire disclosure of which is incorporated by reference herein.

### TECHNICAL FIELD

The disclosure herein relates to a galley monument comprising an integrated charging station for personal electronic devices (PEDs), in particular for installation in passenger aircraft.

### BACKGROUND

Personal electronic devices (PEDs) are becoming ever more common, and the devices are also often being used on board flights, both by passengers and airline employees. Paperless documentation stored on tablet computers or mobile electronic handheld devices is increasingly replacing printed documents such as passenger lists, checklists for aircraft maintenance and the like.

PEDs are often operated by accumulators, for example those based on lithium-ion battery technology. For accumulators of this type on board aircraft, it is desirable for appropriate safety precautions to be taken in order to monitor the operation of the PEDs requiring these accumulators. In addition, it is desirable for the accumulators of PEDs to also recharge during a flight if the electrical power stored therein becomes depleted.

DE 20 2015 106 958 U1 discloses an insert for an aircraft galley for storing and charging personal electronic devices.

### SUMMARY

It is therefore an idea of the present disclosure to find improved solutions for monitoring electronic devices equipped with electrical power storage during charging on board an aircraft.

According to a first aspect of the disclosure herein, a galley monument comprises at least one galley element and at least one charging station integrated in a slide-in compartment in the galley monument for charging electrical energy storage of personal electronic devices.

According to a second aspect of the disclosure herein, an aircraft comprises a galley monument according to the first aspect of the disclosure herein.

A concept of the disclosure herein involves integrating a charging station for personal electronic devices (PEDs) in a galley for an aircraft. This integration may make smoke and/or fire detectors or sensors unnecessary in some cases, since the open design of a galley and the fact that it is easily accessible to flight crew make it easier to initiate emergency measures if there is a fire in the charging station and/or the PEDs during a charging process. In addition, the members of the flight crew are frequently in the vicinity of a galley anyway, and therefore emergency situations can be identified in a rapid and timely manner.

According to some embodiments of the galley monument according to the disclosure herein, the at least one galley element may comprise one or more elements from the group comprising food containers, rolling containers, water heaters, coffee machines, convection ovens, hotplates, sinks, cooling containers and refrigerators.

According to some other embodiments of the galley monument according to the disclosure herein, the charging station may comprise outer walls that surround the charging station on five sides and only allow access from one side.

According to some other embodiments of the galley monument according to the disclosure herein, the outer walls may be cladded with fire-retardant materials or may be made of fire-resistant materials.

According to some other embodiments of the galley monument according to the disclosure herein, the charging station may comprise a door element or a locking element comprising a locking mechanism.

According to some other embodiments of the galley monument according to the disclosure herein, the locking mechanism may be equipped with an emergency intervention mechanism for opening the locking element in emergency situations.

According to some other embodiments of the galley monument according to the disclosure herein, partitions may be retracted into the charging station in the horizontal or vertical direction.

According to some other embodiments of the galley monument according to the disclosure herein, the charging station may have one or more charging interfaces, which can be connected to a central power supply of an aircraft via the galley monument.

According to some other embodiments of the galley monument according to the disclosure herein, the bottom of the charging station may be covered with a non-slip covering.

According to some other embodiments of the galley monument according to the disclosure herein, a warning may be attached to the charging station that encourages users to continuously monitor a device in the charging station while the process of charging the device is ongoing. In this case, in some embodiments, the warning may be printed on a sign that is attached to a side wall or a locking element of the charging station.

The above-mentioned embodiments and developments can be combined in any manner, if appropriate. Further possible embodiments, developments and implementations of the disclosure herein include combinations of features of the disclosure herein described previously or below with respect to the embodiments, even if not explicitly specified. In particular, a person skilled in the art will also add individual aspects as improvements or supplements to the relevant basic form of the present disclosure.

### BRIEF DESCRIPTION OF THE DRAWINGS

The present disclosure will be described in greater detail below with reference to the embodiments shown in the schematic drawings, in which:

FIG. 1 is a view of an example of a galley according to an embodiment of the disclosure herein; and

FIG. 2 is a schematic view of a charging station integrated in a galley monument for personal electronic devices (PEDs) according to another embodiment of the disclosure herein.

The accompanying drawings are intended to facilitate further understanding of the embodiments of the disclosure herein. They illustrate embodiments and, together with the description, they serve to explain principles and concepts of the disclosure herein. Other embodiments and many of the advantages mentioned are clear from the drawings. The elements of the drawings are not necessarily shown to scale relative to one another. Terms specifying direction, such as “upper”, “lower”, “left”, “right”, “above”, “below”, “horizontal”, “vertical”, “front”, “rear” and similar details are used merely for explanatory purposes and are not intended to restrict the generality to specific embodiments as shown in the drawings.

In the figures of the drawings, identical, functionally identical and identically operating elements, features and components are in each case provided with the same reference signs, unless indicated otherwise.

### DETAILED DESCRIPTION

Personal electronic devices (PEDs) in the context of the present disclosure include, for example, all electronic apparatuses which can be used for the purpose of entertainment, communication and/or office work. For example, PEDs can include all types of consumer devices, such as laptops, mobile phones, smartphones, handheld devices, palmtop PCs, tablet PCs, GPS devices, navigation devices, audio equipment such as MP3 players, portable DVD/Blu-ray® players or digital cameras.

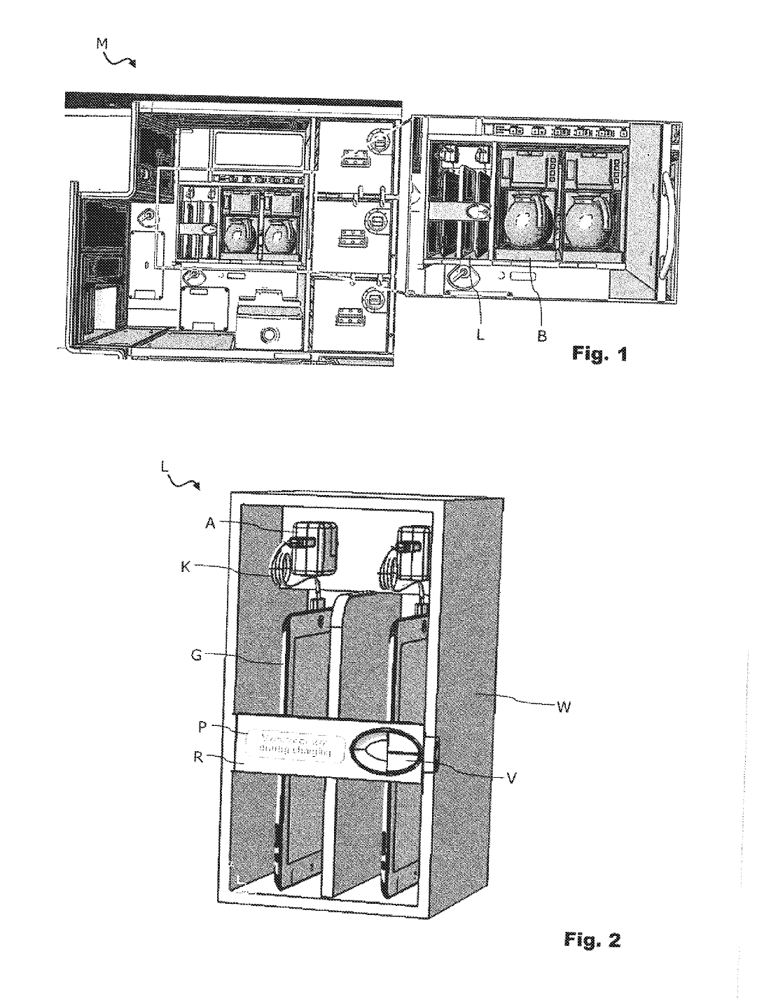

FIG. 1 is a schematic view of a galley monument M (also called a galley) comprising galley elements B. For example, the galley elements B can be optimized for preparing meals and/or beverages in the smallest of spaces. The galley elements B may for example include food containers, rolling containers (trolleys), water heaters, coffee machines, convection ovens, hotplates, sinks, cooling containers, refrigerators and the like.

The galley elements B may be installed in predetermined slide-in compartments in the galley monument M, the dimensions of which compartments are standardised if necessary. One of these slide-in compartments may comprise a charging station L for PEDs. The charging station L of the galley monument M in FIG. 1 is shown on the right-hand side of the figure, beside a slide-in compartment for coffee machines, and is shown in greater detail in FIG. 2.

The charging station L comprises outer walls W that surround the charging station on five sides and only allow access to the devices G or connections A located therein from one side. This side may for example be the side that faces the user of the galley. The outer walls W may optionally be cladded with fire-retardant materials or made of fire-resistant materials, such as steel or the like.

Optionally, the charging station L may be secured against access from the outside by a door element or (as shown in FIG. 2) a locking element R comprising a locking mechanism V, such as a toggle, a lock or a latching element. In this case, the door element may be made of transparent material, in order to ensure that a user of the galley can see the devices G located in the charging station L. The locking element R may for example only cover part of the side wall that is open to the outside, such that a user of the galley can still see the devices G located in the charging station L through regions that are not covered.

The devices G housed in the charging station L can be protected against being stolen or removed without authorization by a door element or a locking element R. For this purpose, the locking mechanism V may for example only be opened by authorized flight crew or by an authorized passenger who has a key. Optionally, the locking mechanism V may be equipped with an emergency intervention mechanism, which allows an authorized person, such as the captain, to override the locking mechanism V in emergencies.

One or more devices L can be stowed or charged in the charging station L at the same time. For this purpose, if required partitions can be retracted into the charging station L in the horizontal or (as shown in FIG. 2) vertical direction, in order to thereby form various storage compartments. The bottom of the respective storage compartments may for example be covered with a non-slip covering, in order to minimise movement of the devices G housed therein, also during flight movements of the aircraft or during turbulence.

A USB cable, an HDMI cable or a similar connecting cable K, for example, can be used to connect a USB port, HDMI port or another port on the PED G to a USB port, HDMI port or other charging interface A in the charging station L, for example at a central connecting point for electrical connections which are connected to a central power supply of the aircraft by the galley monument. Of course, other connection options for connecting the PED G to the charging station L may also be used, for example a near field communication (NFC) connection, a Qi connection or other suitable connection technology for wirelessly transmitting power by electromagnetic induction over short distances.

Air can circulate around devices G located in the charging station L owing to the open construction, and therefore any heat that builds up during the process of charging the device G can be convectively carried away. This can contribute to preventing a device G from overheating. Furthermore, any explosive gases that may potentially escape from the device G can be convectively transported away. Owing to its open design, the entire charging station L is easily accessible when cooling measures and fire-extinguishing measures need to be taken. In addition, cooling agents such as water are usually readily available in the galley.

It may be particularly advantageous for a warning to be attached to the charging station L that encourages users to continuously monitor a device G in the charging station L while the process of charging the device G is ongoing. The warning may for example be printed on a sign P that is attached to a side wall of the charging station L or (as shown in FIG. 2) to the locking element R.

The ports A in the charging station L can be activated or deactivated by central control elements in the galley monument M. In this case, it may be possible to activate and deactivate the ports A together with other galley elements B.

In the detailed description above, various features have been summarized in one or more examples so as to provide a more cogent representation. However, it should be clear here that the above description is of a purely illustrative, but in no way limiting nature. The description serves to cover all alternatives, modifications and equivalents of the various features and embodiments. Many other examples will become immediately clear to a person skilled in the art owing to their expert knowledge in view of the above description.

The embodiments have been selected and described in order to be able to show, as clearly as possible, the principles on which the disclosure herein is based and the possible applications thereof in practice. As a result, persons skilled in the art can optimally modify and use the disclosure herein and the various embodiments thereof with respect to the intended purpose thereof. In the claims and the description, the terms “containing” and “comprising” are used as linguistically neutral terminology for the corresponding term “including”. Furthermore, use of the terms “a”, “an” and “one” is not intended to fundamentally exclude a plurality of such described features and components.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a”, “an” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

1. A galley monument, comprising:
at least one galley element; and
at least one charging station integrated in a slide-in compartment in the galley monument for charging an electrical energy storage of personal electronic devices, which station comprises a locking element having a locking mechanism,
wherein the locking mechanism is equipped with an emergency intervention mechanism for opening the locking element in an emergency situation.

2. The galley monument of claim 1, wherein the at least one galley element comprises one or more elements from the group consisting of food containers, rolling containers, water heaters, coffee machines, convection ovens, hotplates, sinks, cooling containers and refrigerators.

3. The galley monument of claim 1, wherein the charging station comprises outer walls that surround the charging station on five sides and only allow access from one side.

4. The galley monument of claim 3, wherein the outer walls are cladded with fire-retardant materials.

5. The galley monument of claim 3, wherein the outer walls are made of fire-resistant materials.

6. The galley monument of claim 1, wherein partitions are retracted into the charging station in the horizontal or vertical direction.

7. The galley monument of claim 1, wherein the charging station has at least one charging interface, which can be connected to a central power supply of an aircraft via the galley monument.

8. The galley monument of claim 1, wherein a bottom of the charging station is covered with a non-slip covering.

9. The galley monument of claim 1, wherein a warning is attached to the charging station that encourages users to continuously monitor a device in the charging station while charging the device is ongoing.

10. The galley monument of claim 9, wherein the warning is printed on a sign that is attached to a side wall or a locking element of the charging station.

11. An aircraft comprising a galley monument, the galley monument comprising:
at least one galley element; and
at least one charging station integrated in a slide-in compartment in the galley monument for charging an electrical energy storage of personal electronic devices, which station comprises a locking element having a locking mechanism,
wherein the locking mechanism is equipped with an emergency intervention mechanism for opening the locking element in an emergency situation.
